(19) United States
(12) Patent Application Publication
(10) Pub. No.: US 2015/0151514 A1
(43) Pub. Date: Jun. 4, 2015

(54) Laminated Structure, Method of Preparing Same, and Method of Fabricating Electronic Device Using Laminated Structure

(71) Applicant: SAMSUNG ELECTRONICS CO., LTD., Suwon-si (KR)

(72) Inventors: Tomoyuki KIKUCHI, Yokohama (JP); Kazumi NAKAYOSHI, Yokohama (JP); Nobuji SAKAI, Yokohama (JP); Reina IWASAKI, Yokohama (JP)

(21) Appl. No.: 14/550,379

(22) Filed: Nov. 21, 2014

(30) Foreign Application Priority Data
Nov. 29, 2013 (JP) 2013-247517
Nov. 17, 2014 (KR) 10-2014-0159751

(51) Int. Cl. B32B 17/06; B32B 38/00; B32B 37/12; B32B 37/18; B32B 7/12; B32B 27/34

(52) U.S. Cl. CPC B32B 17/064; B32B 7/12; B32B 27/34; B32B 37/1284; B32B 37/182; B32B 38/0008; B32B 2307/306; B32B 2457/00

(57) ABSTRACT

A laminated structure including an inorganic support; a heat resistance polymer film; and an adhesive layer disposed between the inorganic support and the heat resistance polymer film, wherein the adhesive layer includes at least one silsesquioxane polymer.

### CROSS-REFERENCE TO RELATED APPLICATIONS

This application claims priority to Japanese Patent Application No. 2013-247517 filed in the Japanese Patent Office on Nov. 29, 2013 and Korean Patent Application No. 10-2014-0159751 filed in the Korean Intellectual Property Office on Nov. 17, 2014, and all the benefits accruing therefrom under 35 U.S.C. §119, the contents of which are incorporated herein in their entirety by reference.

### BACKGROUND

1. Field

This disclosure relates to a laminated structure including an adhesive layer including at least one silsesquioxane polymer disposed between an inorganic support and a heat resistance polymer film, a method of fabricating the laminated structure, and a method of fabricating an electronic device including the laminated structure.

2. Description of the Related Art

Recently, techniques of forming an electronic device such as a semiconductor device, a MEMS (microelectromechanical systems) device, and a display device on a polymer film have been developed in order to provide a light-weighted, small-sized, thin, and flexible electronic device. Conventionally, the material for an electronic member such as a data communication device (a broadcasting device, a mobile device, a portable communication device, or the like), a radar, or a high-speed information process is a ceramic, wherein the ceramic has heat resistance and simultaneously responds to the requirements of high frequency (reaching a gigahertz zone) for the signal band of a data communication device. However, the ceramic has applicability problems because it is not flexible. In addition, it is hard to reduce a thickness of the ceramic. For forming an electronic device such as a semiconductor device, a MEMS device, or a display device on a polymer film surface, it is desired to employ a roll-to roll process using the flexible characteristic of the polymer film. However, the process techniques for a subject of a hard flat surface substrate such as a wafer substrate or a glass substrate have been established in the fields of the semiconductor industry, the MEMS industry, and the display industry. Therefore, as a practical choice, it is considered that the polymer film is attached to a hard support including an inorganic material, for example, a glass substrate, a ceramic substrate, a silicon wafer, a metal plate, or the like, to form a desirable device thereon, and then delaminated from the support, such that an electronic device formed on the polymer film may be obtained using the conventional infrastructure. Conventionally, the attachment of a polymer film on a support including an inorganic material has been widely performed using an adhesive or a gluing agent. However, when forming a desirable electronic device on a laminated structure in which a polymer film is attached to a support of an inorganic material, the laminated structure is desired to have a trouble-free surface smoothness, dimensional stability, a clean property, process temperature resistance, reagent resistance applicable for the microprocess, or the like, as well as to provide an electronic device. Particularly, a process at a temperature of about 200° C. to 500° C. is required for fabricating an electronic device such as polysilicon or an oxide semiconductor. For example, for fabricating a low temperature polysilicon thin film transistor, heating treatment at 450° C. for about 2 hours may be needed to carry out dehydrogenation, and for fabricating a hydrogenated amorphous silicon thin film, the film may be heated at a temperature ranging from about 200° C. to 300° C. When the temperature for fabricating an electronic device is as high as aforementioned, the polymer film needs to have heat resistance. Also the contact surface between the polymer film and the support, which is a gluing agent or an adhesive, needs to be stable at the process temperature. However, as the conventional gluing agent or adhesive does not have the sufficient heat resistance, it may not have been applied to the electronic device when the fabrication temperature thereof is high. The following Patent Reference 1 discloses a laminated structure in which a plasma-treated polyimide film and a support are attached using a coupling agent. The following Patent Reference 2 discloses an adhesive sheet including an adhesive layer formed using an adhesive including a ladder-type polysilsesquioxane polymer.

Patent Reference 1: Patent laid-open No. 2013-010342

Patent Reference 2: Patent laid-open No. 2008-248236

### SUMMARY

However, the laminated structure disclosed in Patent Reference 1 has problems in that the adhesion is deteriorated since an out-gas is generated from a coupling agent and forms bubbles when exposed to the long-term high temperature process. When bubbles are generated, the film surface morphology becomes uneven and increases the defect rate of the device formed on the film.

As in Patent Reference 1, the adhesive sheet disclosed in Patent Reference 2 also has problems in that the adhesion is deteriorated as a result of the out-gas generated, and forms bubbles when exposed to the high temperature process.

Conventionally, when the electronic device is fabricated on the flexible film substrate, the adhesive layer is exposed to the decomposition temperature or the temperature greater than 300° C., the out-gas of the contents generates bubbles. Such adhesion becomes deteriorated and fails to satisfy the requirements of the process.

The present embodiments solve the above prior art problems and provide a novel and improved laminated structure in which decomposition of the adhesive layer or bubbles forming may be suppressed during the high temperature process, and the long-term high temperature resistance may be improved.

It is disclosed that the above prior art problems may be solved by a laminated structure including an adhesive layer including at least one silsesquioxane polymer disposed between an inorganic support and a heat resistance polymer film.

Thereby, an embodiment has the following features:

(1) A laminated structure including

an inorganic support;

a heat resistance polymer film; and

an adhesive layer including at least one silsesquioxane polymer between the inorganic support and the heat resistance polymer film.

(2) The laminated structure wherein the silsesquioxane polymer includes a structural unit represented by Chemical Formula 1:

*-[R¹SiO_{3/2}]-* Chemical Formula 1

wherein, in the Chemical Formula 1,

R¹ is selected from hydrogen, a C1-C15 alkyl group, and a C6-C15 aromatic hydrocarbon group; and

* represents a point of attachment to an adjacent structural unit.

(3) The laminated structure of entry (2), wherein the silsesquioxane polymer includes a structural unit represented by Chemical Formula 2:

*-[HSiO_{3/2}]-* Chemical Formula 2

wherein in the Chemical Formula 2,

* represents a point of attachment to an adjacent structural unit.

(4) The laminated structure of any one of entries (1) to (3), wherein the silsesquioxane polymer is a ladder-type silsesquioxane polymer.

(5) The laminated structure of any one of entries (1) to (4), wherein the heat resistance polymer film is at least one selected from a polyimide polymer film, a polyamide polymer film, a polybenzoxazole polymer film, and a fluorinated polymer film.

(6) The laminated structure of any one of entries (1) to (5), wherein the adhesive layer has a thickness of about 50 nanometers to about 10 micrometers.

(7) A method of fabricating a laminated structure that includes

disposing an adhesive layer including at least one silsesquioxane polymer on an inorganic support,

activating the adhesive layer,

disposing a heat resistance polymer film on the adhesive layer to obtain a laminating structure precursor, and

heating the laminated structure precursor under pressure to obtain the laminated structure.

(8) The method of entry (7), wherein the activating the adhesive layer is carried out by at least one method selected from plasma treatment, radioactive ray radiation treatment, corona treatment, laser photo-radiation treatment, active gas treatment, and reagent treatment.

(9) A method of fabricating an electronic device using the laminated structure of any one of entries (1) to (6), or the laminated structure fabricated by the fabricating method of entries (7) or (8), and including delaminating the heat resistance polymer film from the adhesive layer.

(10) The method of entry (9), wherein the delaminating is performed by laser abrasion or mechanical delamination.

### DETAILED DESCRIPTION

Hereinafter, embodiments of the present disclosure are described more fully in the following detailed description, in which some but not all embodiments of this disclosure are described, but the present disclosure is not limited to the embodiments. In addition, dimensional ratios in the drawings may be exaggerated and different from actual ratios for ease of explanation. This disclosure may be embodied in many different forms and is not to be construed as limited to the embodiments set forth herein; rather, these embodiments are provided so that this disclosure will fully convey the scope of the invention to those skilled in the art. Thus, in some exemplary embodiments, well-known technologies are not specifically explained to avoid ambiguous understanding of the present inventive concept. Unless otherwise defined, all terms used in the specification (including technical and scientific terms) may be used with meanings commonly understood by a person having ordinary knowledge in the art. Further, unless explicitly defined to the contrary, the terms defined in a generally-used dictionary are not ideally or excessively interpreted. In addition, unless explicitly described to the contrary, the word “comprise” and variations such as “comprises” or “comprising” will be understood to imply the inclusion of stated elements but not the exclusion of any other elements. As used herein, the term “and/or” includes any and all combinations of one or more of the associated listed items. The term “or” means “and/or.” Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In addition, in the specification, “X to Y” indicating a range means “greater than or equal to X and less than or equal to Y”; and “weight” and “mass”, “wt %” and “mass %”, and “parts by weight” and “parts by mass” are considered to be synonyms. In addition, unless stated otherwise, the processing and measuring physical properties or the like are performed under the conditions of room temperature (about 20° C. to about 25° C.) and relative humidity of about 40% to about 50%.

As used herein, the term “alkyl group” refers to a straight or branched chain, saturated, monovalent hydrocarbon group having a specified number of carbon atoms.

As used herein, the term “aromatic hydrocarbon group” refers to a monovalent group formed by the removal of one hydrogen atom from one or more rings of an aromatic hydrocarbon. The aromatic hydrocarbon may be a monocyclic aromatic hydrocarbon or a polycyclic aromatic hydrocarbon. When the aromatic hydrocarbon is a polycyclic aromatic hydrocarbon, the additional rings of the polycyclic aromatic hydrocarbon may be aromatic or nonaromatic.

An embodiment provides a laminated structure including

an inorganic support;

a heat resistance polymer film; and

an adhesive layer disposed between the inorganic support and the heat resistance polymer film,

wherein the adhesive layer includes at least one silsesquioxane polymer.

Because of the laminated structure, the adhesive layer is prevented from exposure to the decomposition temperature even if the process temperature for fabricating the electronic device may reach over about 300° C. As a result, the adhesive deterioration due to adhesive layer decomposition or bubbles formation may be prevented by suppressing the gas generation of its contents.

Hereinafter, the laminated structure according to the embodiment is described in detail.

### Adhesive Layer

The laminated structure according to the embodiment includes

an inorganic support;

a heat resistance polymer film; and

an adhesive layer including at least a silsesquioxane polymer disposed between the inorganic support and the heat resistance polymer film.

Silsesquioxane Polymer

The silsesquioxane polymer included in the adhesive layer of the laminated structure according to the embodiment is a compound having a main chain of siloxane bonds (Si—O—Si), which may form a polysiloxane networks having a ladder-type, a basket-type, and a random-type structure. The composition ratio of the silsesquioxane polymer is represented by the formula [RSiO_{3/2}]. This polymer is a tri-functional T polymer which is defined as an intermediate material between inorganic silica represented by the formula [SiO₂] and organic silicon represented by the formula [R₂SiO]. The silsesquioxane polymer is generally soluble in an organic solvent. It is easily handled, and has excellent characteristics of workability such as coating property, formability, and the like.

According to an embodiment, the laminated structure is subjected to the pressure-heating process described below. In other words, an embodiment provides a pressure-heated laminated structure including:

an inorganic support;

a heat resistance polymer film; and

an adhesive layer including at least a silsesquioxane polymer disposed between the inorganic support and the heat resistance polymer film.

Another embodiment provides a laminated structure in which an adhesive layer including at least one silsesquioxane polymer is activated and subjected to a pressure-heating process as described below. In other words, an embodiment provides a pressure-heated laminated structure including:

an inorganic support;

a heat resistance polymer film; and

an activation-treated adhesive layer disposed between the inorganic support and the heat resistance polymer film, wherein the adhesive layer includes at least one silsesquioxane polymer.

In an exemplary embodiment, the silsesquioxane polymer of the adhesive layer of the laminated structure according to the embodiment includes a structural unit represented by Chemical Formula 1:

*-[R¹SiO_{3/2}]-* Chemical Formula 1

In the above Chemical Formula 1,

R1 is selected from hydrogen, a C1-C15 alkyl group and a C6-C15 aromatic hydrocarbon group; and

* represents a point of attachment to an adjacent structural unit.

The C1-C15 alkyl group may be a linear alkyl group such as a methyl group, an ethyl group, an n-propyl group, an n-butyl group, and the like; a branched alkyl group such as an isopropyl group, a tert-butyl group, and the like; and a cyclic alkyl group excluding one hydrogen atom from cyclopentane, cyclohexane, adamantane, norbornane, such as cyclopentyl, cyclohexyl, adamantyl, norbornyl, and the like.

The C6-C15 aromatic hydrocarbon group may be a monocyclic aromatic group or a polycyclic aromatic group. The polycyclic aromatic group may be a fused polycyclic aromatic group or a combination of monocyclic aromatic groups connected by a single bond. For example, the C6-C15 aromatic hydrocarbon group may be a phenyl group, a naphthyl group, an anthracenyl group, a biphenyl group, and the like, and for example, a phenyl group, a naphthyl group, and the like.

The weight average molecular weight of the silsesquioxane polymer included in the adhesive layer is not particularly limited since it may be partially depolymerized by the activation-treatment described below, and may range from about 1,500 to about 30,000. The silsesquioxane polymer of the adhesive layer may be a ladder-type silsesquioxane polymer.

According to an embodiment, the adhesive layer may be formed from a silsesquioxane including the structural unit represented by Chemical Formula 1. In this case, the gross amount of carbon (C), oxygen (O), silicon (Si), and hydrogen (H) may be greater than or equal to about 80 atomic percent (atom %) based on the total atom composition of the laminated structure, and may be, for example, greater than or equal to about 90 atom %, greater than or equal to about 95 atom %, or greater than or equal to about 98 atom %.

The upper limit of the gross amount of carbon (C), oxygen (O), silicon (Si), and hydrogen (H) is not particularly limited, and may be, for example, about 100 atom %.

The adhesive layer may also include impurity atoms such as nitrogen. However, the fewer impurity atoms are included in the adhesive layer, the better its performance. Without particular limitation, each impurity atom may be present in an amount of, for example, less than about 10 atom %, for example, less than about 5 atom %, for example, less than about 2 atom %, for example, or less than about 1 atom %. The lower limit of an amount of impurity atoms is not particularly limited, and each impurity atom may be present in an amount of greater than or equal to 0 atom %, for example, greater than 0 atom %.

In another embodiment, the silsesquioxane polymer of the adhesive layer of the laminated structure includes a structural unit represented by Chemical Formula 2:

*-[HSiO_{3/2}]-*, Chemical Formula 2

wherein in the Chemical Formula 2,

* represents a point of attachment to an adjacent structural unit.

When the silsesquioxane polymer including the structural unit represented by Chemical Formula 2 is included in the adhesive layer of the laminated structure, the long-term high temperature resistance of the laminated structure may be improved. While not wanting to be bound by theory, it is understood that the conventional silsesquioxane polymer including the functional group including carbon may be readily degraded at high temperature to cause bubbles formation. In contrast, the silsesquioxane polymer represented by Chemical Formula 2 is terminated with hydrogen, making it difficult to cause formation of bubbles.

The structural unit represented by Chemical Formula 2 corresponds to the structural unit represented by Chemical Formula 1, wherein R¹ is H. The silsesquioxane polymer of the adhesive layer of the laminated structure may have structural units in which only a part of groups R¹ is H (hydrogen atom), but it may also have structural units in which all groups R¹ are H. In the latter case, the terminal group of the silsesquioxane polymer may be a hydroxyl group and/or a hydrogen atom, for example, a hydrogen atom.

According to an embodiment, the adhesive layer may be formed with hydrogen silsesquioxane including the structural unit of Chemical Formula 2. In this case, the total amount of oxygen (O), silicon (Si), and hydrogen (H) may be greater than or equal to about 80 atom %, for example, greater than or equal to about 90 atom %, for example, greater than or equal to about 95 atom %, for example, or greater than or equal to about 98 atom % based on the total atom composition of the laminated structure. The upper limit of the total amount of oxygen (O), silicon (Si), and hydrogen (H) is not particularly limited, and may be, for example, 100 atom %.

The composition ratio of oxygen (O), silicon (Si), and hydrogen (H) in the adhesive layer may be, for example, about 1.5:1:1.

Other atoms such as carbon (C) or nitrogen (N) may be present in the adhesive layer from the impurities. However, the fewer these atoms are present in the adhesive layer, the better its performance. Without particular limitation, each atom may be present at less than about 10 atom %, for example, less than about 5 atom %, for example, less than about 2 atom %, or for example, less than about 1 atom %. The lower limit of the impurity atoms is not particularly limited, but each impurity atom may be present in an amount of greater than or equal to 0 atom %, for example, greater than 0 atom %.

As long-term high temperature resistance is desired, the less carbon (C) included in the adhesive layer, the better the long-term high temperature resistance of the adhesive layer is.

The atom composition of the adhesive layer may be obtained according to any method known to one of ordinary skill in the art, for example, an XPS method or the like.

Thickness of Adhesive Layer

According to the embodiment, the adhesive layer including at least silsesquioxane polymer may have a thickness of, for example, about 50 nanometers (nm) to about 10 micrometers (μm), for example, about 100 nm to about 5 μm, or for example, about 500 nm to about 1 μm.

When the thickness of the adhesive layer is greater than about 50 nm, the adhesion may be stronger, and when the thickness is less than about 10 μm, the solvent may be readily removed from the adhesive layer during the activation-treatment or the pressure-heating treatment.

The thickness of adhesive layer may be measured by, for example, probe-type surface profiler such as Dektak 8 (manufactured by ULVAC, Inc.).

Other Components of Adhesive Layer

According to the embodiment, the adhesive layer of the laminated structure may include other components such as a curing agent without limitation, other than the silsesquioxane polymer.

The curing agent may include a conventionally known thermal curing agent, photopolymerization initiator, and the like.

Adhesion Strength of Adhesive Layer

The adhesion strength of the adhesive layer of the laminated structure according to the embodiment may be measured by a 180° peel test (based on the peel adhesion strength test of JIS Z0237). Specifically, a specimen (25 mm×100 mm) cut from the laminated structure is held by a chuck at the terminal end of the heat resistance polymer film and folded at 180° and peeled at a speed of 5 millimeters per second (mm/s) to measure the adhesion strength. The adhesion strength of the adhesive layer according to the embodiment is not particularly limited, but may be appropriately determined according to the purpose of use, the process conditions, or the like of the device to be obtained. However, the adhesion strength measured directly after forming the laminated structure may be greater than or equal to about 1 Newton per centimeter (N/cm), or for example, greater than or equal to about 10 N/cm. The upper limit is not particularly limited, but may be, for example, about 24 N/cm.

In addition, the specimen cut from the laminated structure is heated at about 350° C. for about 2 hours, and the adhesion strength measured by the method may be greater than or equal to about 0.1 N/cm, for example, greater than or equal to about 1 N/cm, or, for example, greater than or equal to about 10 N/cm. The upper limit is not particularly limited, but may be, for example, about 24 N/cm.

Inorganic Support

According to the embodiment, the inorganic support for the laminated structure may include any material having heat resistance at a high temperature range from about 200° C. to about 500° C. without particular limitation. For example, the inorganic support may be a substrate applied for the conventional process for a flat substrate such as a wafer base.

According to the embodiment, the inorganic support for the laminated structure may not be particularly limited, but it may include, for example, a metal plate including an alloy of a metal such as copper, aluminum, iron, gold, or platinum and stainless steel, and the like; a thermoresist glass substrate such as quartz glass and soda lime glass, for example, borosilicate glass such as Pyrex (registered trademark), Tenpax (registered trademark), Baycol (registered trademark), and the like, for example, a non-alkali glass such as EAGLE XG (registered trademark) (manufactured by Corning) or the like; a ceramic substrate such as alumina, zirconia, titania, spinel, mullite, SiAlON, sapphire, silicon carbide, aluminum nitride, silicon nitride, cogylight, and the like; a silicon substrate; a graphite substrate, and the like.

The thickness of the inorganic support is not particularly limited, but may range, for example, from about 10 μm to about 10 mm without limitation.

The inorganic support for the embodiment may have surface roughness Ra (mathematic average roughness) of less than or equal to about 10 nm, for example, less than or equal to about 5 nm.

When the surface roughness Ra is less than or equal to about 10 nm, the adhesive layer and the heat resistance polymer film maintain smoothness on the inorganic support.

Heat Resistance Polymer Film

According to the embodiment, the heat resistance polymer film may be a polymer film used in a material for an electronic device such as a semiconductor device, a MEMS device, and a display device, and may include a material having a melting point of greater than about 300° C.

The heat resistance polymer film of the laminated structure according to the embodiment is not particularly limited, but may be, for example, a polyimide (PI); a polyamide such as a polyamide 6 (PA6), polyamide 66 (PA66), aramid, and the like; a fluorinated polymer or copolymer such as polytetrafluoroethylene (PTFE), a tetrafluoroethylene.perfluoroalkoxyethylene copolymer (PFA), a tetrafluoroethylene.hexafluoropropylene copolymer (FEP), and the like; a polyethylene terephthalate (PET); a polyethylene naphthalate (PEN); a polysulfone (PSU); a polyether sulfone (PES); a polyamideimide (PAI); a polyetherimide (PEI); a polyphenylene sulfide (PPS); a polyetheretherketone (PEEK); a liquid crystal polymer (LCP); a polybenzoxazole; and the like. Among them, the polyimide film, the polyamide film, the polybenzoxazole film, or the fluorinated polymer film may be used. For example, the polyimide film may be used in terms of heat resistance, a raw material cost, and the like.

The thickness of the heat resistance polymer film is not particularly limited, and may be appropriately determined according to the purpose of use, the process conditions, and the like, of the prepared device. It may range, for example, from about 1 μm to about 1,000 μm, for example, from about 5 μm to about 200 μm, or, for example, from about 15 μm to about 40 μm.

### Fabricating Method of Laminated Structure

The laminated structure according to the embodiment may be fabricated by forming an adhesive layer on a heat resistance polymer film, and laminating the heat resistance polymer film on an inorganic support to dispose the adhesive layer between the inorganic support and the heat resistance polymer film.

For example, a method of fabricating a laminated structure according to the embodiment includes:

disposing (forming) an adhesive layer including at least one silsesquioxane polymer on an inorganic support,

activating the adhesive layer (activation-treating the adhesive layer),

disposing (laminating) a heat resistance polymer film on the adhesive layer to obtain a laminated structure precursor, and

heating the laminated structure precursor under pressure (pressure-heating).

Hereinafter, a method of fabricating the laminated structure according to the embodiment is described in detail.

Process of Forming Adhesive Layer

The laminated structure according to the embodiment may be obtained by forming an adhesive layer including at least one silsesquioxane polymer on an inorganic support, and laminating a heat resistance polymer film on the inorganic support to dispose the adhesive layer between the inorganic support and the heat resistance polymer film.

In other words, the method of fabricating the laminated structure according to the embodiment includes forming an adhesive layer including at least one silsesquioxane polymer on an inorganic support.

In this case, forming an adhesive layer is not particularly limited, but may include a film forming method of applying a coating solution including at least one silsesquioxane polymer on an inorganic support.

The laminated structure according to the embodiment may be obtained by forming an adhesive layer including at least one silsesquioxane polymer on a heat resistance polymer film, and laminating the heat resistance polymer film on an inorganic support to dispose the adhesive layer between the inorganic support and the heat resistance polymer film.

The silsesquioxane polymer used for forming an adhesive layer is not particularly limited, but may be obtained according to a known method in the art.

The silsesquioxane polymer may be a commercially available silsesquioxane polymer. For example, it may be HSQ (Tokyo Ohka Kogyo Co., Ltd.); SR-13, SR-20, SR-21, SR-23, or SR-33 (Konishi Chemical Ind. Co., Ltd.); OX-SQ, OX-SQ-H, OX-SQ SI-20, OX-SQ-F, MAC-SQ-F, or AC-SQ-F (Toagosei, Co., Ltd.); KMP-590 or KMP-591(Shin-Etsu Chemical Co., Ltd.); and the like.

The weight average molecular weight of the silsesquioxane polymer used for the laminated structure is not particularly limited, but may range from about 2,000 to about 30,000, for example, from about 3,000 to about 15,000.

When the silsesquioxane has the weight average molecular weight within the range, it may have excellent solubility in an organic solvent.

The weight average molecular weight (Mw) of the silsesquioxane polymer may be measured by a method known to one of ordinary skill in the art such as a gel permeation chromatography (GPC).

When the adhesive layer including at least one silsesquioxane polymer is formed according to a film forming method, the coating solution including at least one silsesquioxane polymer is coated on the inorganic support to provide an adhesive layer.

The solvent for providing the coating solution including at least one silsesquioxane polymer may include, for example, alcohols such as methanol, ethanol, propanol, n-butanol, and the like; polyhydric alcohols such as ethylene glycol, diethylene glycol, propylene glycol, dipropylene glycol, and the like; ketones such as acetone, methyl ethyl ketone, cyclohexanone, methyl n-amyl ketone, methyl isoamyl ketone, 2-heptanone, and the like; an ester bond-containing compound such as ethylene glycol monoacetate, diethylene glycol monoacetate, propylene glycol monoacetate, or dipropylene glycol monoacetate, and the like; derivatives of polyhydric alcohols of an ether bond-containing compound and the like such as the polyhydric alcohols or a monoalkyl ether such as a monomethyl ether, monoethyl ether, monopropyl ether, monobutyl ether, and the like; or a monophenyl ether of the ester bond-containing compound, and the like; for example, propylene glycol monomethyl ether acetate (PGMEA), propylene glycol monomethyl ether (PGME), and the like; cyclic ethers such as dioxane and the like; esters such as methyl lactate, ethyl lactate, methyl acetate, ethyl acetate, butyl acetate, methyl pyruvate, ethyl pyruvate, methoxy methyl propionate, ethoxy ethyl propionate, and the like; and aromatic-based organic solvents such as anisole, ethyl benzyl ether, cresyl methyl ether, diphenyl ether, dibenzyl ether, phenetol, butyl phenyl ether, ethylbenzene, diethylbenzene, amylbenzene, isopropyl benzene, toluene, xylene, cymene, mesitylene, and the like. The organic solvent may be one of the above solvents, or may be a mixture of two or more of the above solvents. Among them, PGMEA, PGME, n-butanol, or the like may be used.

The amount of silsesquioxane polymer included in the coating solution is not particularly limited, but may be such as to provide a concentration of a siloxane polymer based on the entire coating solution at about 0.1 percent by mass (mass %) to about 40 mass %, for example, about 1 mass % to about 30 mass %.

When the solvent for providing a coating solution including at least one silsesquioxane polymer remains in the laminated structure, it may generate bubbles upon a long-term exposure to a high temperature during the process of fabricating an electronic device. Accordingly, the amount of solvent remaining in the laminated structure may be about 1,000 mg/m³ (ppm) to about 50,000 mg/m³ (ppm), for example, about 1,000 mg/m³ (ppm) to about 5,000 mg/m³ (ppm). As used herein, “mg/m³” represents the total amount (mg) of solvent included per 1 m³ of adhesive layer, after forming the laminated structure, and particularly, after the pressure-heating treatment and before fabricating an electronic device.

The remaining solvent amount may be measured according to any analysis method known to one of ordinary skill in the art, such as gas chromatography (GC).

Before applying the coating solution including at least one silsesquioxane polymer on the inorganic support, the surface of the inorganic support that will be contacted with the adhesive layer may be cleaned. The cleaning is not particularly limited, but may be appropriately selected from UV ozone treatment, ultrasonic wave treatment, cleaning solution treatment, or the like.

The application of a coating solution including at least one silsesquioxane polymer on the inorganic support may include a conventional suitable wet coating method. The coating method may include spin coating, roll coating, flow coating, Inkjet coating, spray coating, print coating, dip-coating, flow casting, bar coating, gravure printing, or the like.

The coating thickness may be appropriately determined according to the desirable thickness or purpose. The thickness of the adhesive layer may be considered, and may range, for example, from about 50 nm to about 10 μm.

After applying the coating solution, the film may be dried.

The organic solvent included in the film may be removed by drying the film.

In this case, the organic solvent included in the film may be totally dried, or some of the solvent may still remain.

The remaining amount of solvent may be decreased and/or completely removed by a following activation treatment.

The drying temperature of the film may differ depending on the kind of silsesquioxane polymer or the solvent used for preparing the coating solution, and may range from about 50° C. to about 200° C.

The temperature may be adjusted by using a hot plate, an oven, a furnace, or the like.

The drying time may be, for example, about 0.5 minutes to 10 minutes when the drying temperature is about 100° C.

In addition, the drying atmosphere may be selected from an air atmosphere, a nitrogen atmosphere, an argon atmosphere, a vacuum atmosphere, a reduced pressure atmosphere, an atmosphere with a controlled oxygen concentration, and the like.

Activation-Treatment

The method of fabricating the laminated structure according to the embodiment may further include activation-treating the adhesive layer including at least one silsesquioxane polymer formed on the inorganic support.

By performing the following activation-treatment for the adhesive layer formed on the support, a non-bonding part of Si or O is formed to improve adhesion.

The solvent remaining in the adhesive layer or trace amount of impurities present on the adhesive layer may cause formation of bubbles during the process of fabricating an electronic device. As the adhesive layer, including at least one silsesquioxane polymer formed on the inorganic support, undergoes activation-treatment, the solvent remaining in the adhesive layer or a trace amount of impurities on the adhesive layer may be decreased and/or removed. Accordingly, by the activation-treatment, the bubble formation may be suppressed, and the adhesion deterioration caused by a long-term exposure to high temperatures may be suppressed.

The activation-treating the adhesive layer may be performed by, for example, a plasma treatment, a radioactive ray radiation treatment, a corona treatment, a laser light radiation treatment, an active gas treatment, and a reagent treatment, for example, may be performed by a plasma treatment or a radioactive ray radiation treatment, and for example, may be performed by a plasma treatment.

These activation treatments may be performed by a combination of the above treatment methods, but one kind of activation-treatment may be performed in the view of work efficiency.

Plasma Treatment

The plasma treatment used for the activation-treatment of adhesive layer may include a variety of methods known to one of ordinary skill in the art, and may include an RF (Radio Frequency) plasma treatment, a VHF (Very High Frequency) plasma treatment, a UHF (Ultra High Frequency) plasma treatment, a microwave plasma treatment, a microwave ECR plasma treatment, an atmospheric pressure plasma treatment, or the like, and fluorine-included gas treatment, ion injecting treatment using an ion-source, a PBII (Plasma Based Ion Implantation) treatment, frame treatment, ITRO surface treatment (surface treatment for improving close contacting property), or the like. Among them, it may include an RF plasma treatment, a VHF plasma treatment, a UHF plasma treatment, or a microwave plasma treatment.

The plasma treatment may be performed under reduced pressure (vacuum plasma treatment).

The reaction gas used in the plasma treatment is not particularly limited, but may be a fluorocarbon-based gas including fluorine such as CF₄, C₂F₆, C₄F₈, CH₂F₂, CHF₃, and the like, and may be plasma-discharged as a mixed gas with a carrier gas such as Ar, CO₂, H₂, N₂, and Ne to provide plasma having many active species and to improve the activation-treating effects.

The reaction gas may have a flow rate of about 10 standard cubic centimeters per minute (sccm) to about 100 sccm, and the carrier gas may have a flow rate of about 50 sccm to about 200 sccm.

The plasma output may be determined within the range from about 100 watts (W) to about 500 W without limitation, for example, from about 100 W to about 300 W.

The plasma treatment time is not particularly limited, but may range from about 0.1 minute to about 20 minutes, for example, from about 0.5 minute to 10 minutes.

As the plasma treatment time is greater than or equal to about 0.1 minute, the forming non-bond part in the adhesive layer and the removing of the remaining solvent and impurities or the like may be substantially performed.

In the view of productivity, the plasma treatment time may be less than or equal to about 20 minutes.

The pressure (vacuum degree) in the plasma treatment may be positively arranged according to the kind of the raw material gas or the like.

The plasma treatment may be performed under an atmospheric pressure, or may be performed by reducing pressure to about 10 pascals (Pa) to about 100 Pa (vacuum plasma treatment).

The plasma treatment may be performed at one time, or it may be repeatedly performed on the adhesive layer several times.

Radioactive Ray Radiation Treatment

The radioactive ray radiation treatment employed for the activation treatment of the adhesive layer refers to the treatment wherein the adhesive layer is subjected to radiation such as an electron beam, alpha rays, X-rays, beta-rays, infrared rays, visible rays, ultraviolet (UV) rays, or laser light. Among them, the ultraviolet (UV) radiation treatment may be performed, for example, with excimer lamp radiation treatment.

In the ultraviolet (UV) radiation treatment, any ultraviolet (UV) generator available in the market may be used.

In an embodiment, electromagnetic waves having a wavelength of about 10 nm to about 400 nm are used as ultraviolet (UV) rays.

The ultraviolet (UV) radiation time may range from about 1 second (s) to about 60 s, for example, from about 10 s to about 30 s.

The energy density applied to the adhesive layer may range from about 5 millijoules per square centimeter (mJ/cm²) to about 1 J/cm², for example, from about 10 mJ/cm² to about 700 mJ/cm². When the energy density is greater than or equal to about 5 mJ/cm², the non-bonding part in the adhesive layer may be formed, and the remaining solvent impurities may be substantially removed. When the energy density is less than or equal to about 1 J/cm², the generation of cracks on the laminated structure caused by excessive ultraviolet (UV) radiation may be prevented.

The light source of the ultraviolet (UV) radiation treatment is not particularly limited, but may include, for example, an excimer lamp (single wavelength of about 172 nm, about 222 nm, or about 308 nm), a metal halide lamp, a high-pressure mercury lamp, a low pressure mercury lamp, a xenon arc lamp, a carbon arc lamp, a UV light-laser, or the like.

The radioactive ray radiation treatment may be performed on the adhesive layer once, or may be performed repeatedly.

Corona Treatment

The activation-treatment of the adhesive layer may be performed with a corona treatment.

The corona treatment refers to a treatment wherein the adhesive layer is exposed to a corona discharge atmosphere generated in a gas under atmospheric pressure atmosphere or to a treatment of colliding the adhesive layer with ions generated by the discharge.

Laser Beam Radiation Treatment

The activation-treatment of adhesive layer may be performed by a laser beam radiation treatment.

By performing an activation-treatment by a laser beam radiation treatment, the direct-depicting mode is readily carried out. Under this treatment, as even the visible light laser has much higher energy than the general visible ray, it may be considered as an example of radioactive ray in the embodiment.

Active Gas Treatment

The activation-treatment of the adhesive layer may be performed by an active gas treatment.

The active gas treatment refers to a treatment wherein the adhesive layer surface including a silsesquioxane polymer is exposed to the active gas to impart chemical or physical change, for example, a halogen gas, a halogenated hydrogen gas, ozone, a highly concentrated oxygen gas, ammonia, an organic alkali, an organic acid, and the like.

Reagent Treatment

The activation-treatment of the adhesive layer may be performed by a reagent treatment.

The reagent treatment refers to a treatment wherein the adhesive layer surface including a silsesquioxane polymer is exposed to an active liquid or solution to impart a chemical or physical change in the adhesive layer, for example, an alkali solution, an acid solution, a reducing agent solution, an oxidizing agent solution, and the like.

Laminating Heat Resistance Polymer Film and Pressure-Heating Treatment

The method of fabricating the laminated structure according to the embodiment may include laminating a heat resistance polymer film on an adhesive layer formed on a support, and heating the same under pressure (pressure heating). The laminating the heat resistance polymer film on the adhesive layer and the pressure-heating the same may be performed after activation-treating the adhesive layer.

By laminating the heat resistance polymer film on the adhesive layer formed on the support and pressure-heating the same, the bond formation between the adhesive layer and the heat resistance polymer film is accelerated. Furthermore, as the minor amount of remaining solvent in the adhesive layer is removed, the formation of bubbles during the long-term high temperature process is suppressed to enforce the adhesion between the adhesive layer and the heat resistance polymer film.

The laminating the heat resistance polymer film and pressure-heating the same may be performed by laminating the heat resistance polymer film on the adhesive layer formed on the support and by heating the same with a press, a laminator, a roll laminator, or the like, which is heated, under the atmospheric pressure atmosphere or under the vacuum atmosphere. Alternatively, the laminated heat resistance polymer film and the adhesive layer formed on the support may be treated with the pressure-heating treatment in a flexible bag.

In view of productivity or process cost, the heat resistance polymer film may be roll laminated or pressed under vacuum or atmospheric pressure. For example, the laminating may be performed using the roll (roll laminator or the like).

When the pressure-heating treatment is performed using roll laminator, the pressure may range from about 1 megapascals (MPa) to about 20 MPa, for example, from about 3 MPa to about 10 MPa. When the pressure is excessively high, it is possible to break the support. On the other hand, when the pressure is excessively low, some parts may not be in close contact, and therefore, insufficient adhesion may take place.

In addition, the temperature during the pressure-heating treatment may range from about 100° C. to about 400° C., for example, from about 120° C. to about 300° C. When the temperature is excessively high, the heat resistance polymer film may be damaged. On the other hand, when the temperature is excessively low, the adhesion tends to be weak.

When the pressure-heating treatment is performed by roll lamination, the film returning speed may be appropriately controlled by pressure or temperature of the pressure-heating treatment. The film returning speed may range, for example, from about 0.1 meters per minute (m/min) to about 3 m/min.

The pressure-heating treatment may be performed under the atmospheric pressure as described above, or under the vacuum. By performing the pressure-heating treatment under the vacuum, peel strength stability for the entire surface may be provided. Under this type of treatment, the vacuum degree of less than or equal to about 1,000 Pa created by a common oil rotary pump is considered to be sufficient.

When the pressure-heating treatment is performed by a vacuum pressurization press, the heat resistance polymer film and the inorganic support may be exposed to a pressure of about 0.2 MPa to about 50 MPa, for example, of about 30 MPa to about 50 MPa, for about 5 minutes to about 90 minutes, for example, about 10 minutes to about 60 minutes, while heating the same at about 100° C. to about 400° C., for example, at about 120° C. to about 300° C.

The device for the pressure-heating treatment may include, for example, KVHC equipment fabricated by Kitagawa Denki Inc. in order to carry out pressing under vacuum, and may include, for example, MVLP equipment fabricated by Meiki Co. Ltd. in order to perform the vacuum lamination such as the lamination with a roll-type film laminator under vacuum or a film laminator which presses at once on the entire glass surface by a thin rubber film after the evaporation. The pressure-heating treatment may be separated into a pressing process and a heating process. When both the pressing process and the heating process are separately performed, either process may be performed first.

### Method of Fabricating Electronic Device Using Laminated Structure

An embodiment provides the laminated structure or a method of fabricating an electronic device including the laminated structure obtained by the method, wherein the method of fabricating an electronic device includes delaminating the heat resistance polymer film from the adhesive layer.

In other words, the method of fabricating an electronic device according to the embodiment includes:

forming an electronic device on the laminated structure or the heat resistance polymer film of the laminated structure obtained by the method, and

delaminating the heat resistance polymer film formed with the electronic device from the inorganic support.

In the embodiment, the method of forming an electronic device on the heat resistance polymer film which is a substrate may be performed according to any conventional method known to one of ordinary skill in the art.

The electronic device according to the embodiment is not particularly limited, but may include, for example, a coil, a condenser, a semiconductor device, a MEMS device, a display device (for example, an organic electro-luminescence device disclosed in Japanese Patent laid-open No. 2005-174717), a thin film transistor (for example, a thin film transistor disclosed in Japanese Patent laid-open No. 2009-105413), a photoelectric conversion device (for example, a photoelectric conversion device disclosed in Japanese Patent laid-open No. 2010-118158), a sensor, an electronic circuit system, or the like.

In addition, the method of fabricating an electronic device according to the embodiment may also be used to fabricate a heat resistance polymer film (substrate for an electronic device disclosed in, for example, Patent laid-open No. 2012-240356) which is a substrate for the electronic device.

The conventional method of fabricating the electronic device disclosed in the prior art may be appropriately referenced in the embodiment.

Delaminating Process

In the method of fabricating the electronic device according to the embodiment, an electronic device is formed on the laminated structure or the heat resistance polymer film of the laminated structure obtained by the method, and the heat resistance polymer film formed with the electronic device is delaminated from the inorganic support.

According to the embodiment, the delaminating may include (laser) abrasion, mechanical delaminating, or the like.

The method of evaluating the peeling property may be performed by qualitatively measuring the remaining amount of the adhesive layer by analyzing the surface of the heat resistance polymer film by Fourier transform infrared spectroscopy (FT-IR). Particularly, it is confirmed that there is no adhesive layer on the surface of heat resistance polymer film based on the results that no O—Si—O stretching mode spectrum is found in a range of about 900 reverse centimeters (cm⁻¹) to about 1200 cm⁻¹ after delaminating the heat resistance polymer film from the adhesive layer.

Laser Abrasion

The abrasion refers to irradiating the adhesive layer with light to excite the light-absorbed adhesive layer in a photo-chemical or thermal way and to break the atomic or molecular bonds on the surface or in the interior to be discharged. The abrasion may be shown by a phase change phenomenon such as melting, evaporating, and the like of all or a part of the composition material of an adhesive layer. In addition, it may be finely foamed by the phase change, and the bonding force may be deteriorated.

The light radiation source may include any one of, for example, X-rays, ultraviolet (UV) rays, visible light rays, infrared rays, laser light rays, millimeter waves, microwaves, electron beams, radiation, or the like. Among them, in the view of ease of abrasion, the laser light (laser abrasion) may be used in the embodiment.

The laser light may include any kind of gas laser, solid laser (semiconductor laser), or the like. Among them, an excimer laser, a Nd-YAG laser, an Ar laser, a CO₂ laser, a CO laser, a He—Ne laser, or the like may be used. For example, the excimer laser may be used.

When delaminated by laser abrasion, the adhesive layer is irradiated with, for example, a Xe—Cl excimer laser (wavelength: 308 nm) and delaminated (intralayer delamination and interface delamination).

The laser radiation may be performed from the side of the inorganic support.

The laser radiation time may be greater than or equal to about 1 nanoseconds (ns), for example, greater than or equal to about 10 ns. The upper limit of radiation time is not particularly limited, but may be less than or equal to, for example, about 30 ns.

The adhesive layer may have energy density of greater than or equal to about 200 mJ/cm², for example, of greater than or equal to about 250 mJ/cm². When the energy density is greater than or equal to about 200 mJ/cm², the bond between the adhesive layer and the heat resistance polymer film may be substantially cut. The upper limit of energy density is not particularly limited, but may be less than or equal to 300 mJ/cm² considering the possibility of damage to the electronic device including the heat resistance polymer film or the illumination of the used light source.

On the other hand, when an excimer laser is used for delamination, the excimer laser radiation may include spot beam radiation and line beam radiation. In the case of the spot beam radiation, the adhesive layer is spot-radiated in a predetermined unit area (for example, 8 mm×8 mm), and the spot radiation is continued by shifting the radiation by about 1/10 of the unit area.

In the case of a line beam radiation, the radiation is continued by shifting the radiation by about 1/10 of a predetermined unit area as above.

The laser radiating is performed by shifting the radiation area to the entire adhesive layer surface.

Mechanical Delaminating

The mechanical delaminating is a method of physically mechanically delaminating the heat resistance polymer film from the adhesive layer.

With techniques such as using a spatula or wire known by a person of ordinary skill in the art, the interface between the heat resistance polymer film and the adhesive layer becomes broken and the adhesive layer may be peeled and delaminated.

### EXAMPLES

The effects of the embodiment are described using the following examples and comparative examples. However, the technical scope of the embodiment is not limited to the following examples.

### Example 1

As the silsesquioxane polymer, a hydrogen silsesquioxane polymer (silsesquioxane polymer wherein each R¹ in the structural unit represented by Chemical Formula 1 is hydrogen (H)) is used, the activation-treatment is performed through vacuum plasma treatment, and the pressure-heating treatment is performed using a roll laminator to provide a laminated structure including an adhesive layer including a silsesquioxane polymer disposed between an inorganic support and a heat resistance polymer film.

(1) Cleaning Inorganic Support

As the inorganic support, a glass substrate (EAGLE XG; fabricated by Corning, thickness of 700 μm) is used. Before forming the adhesive layer, the glass substrate is cleaned by a UV ozone device (fabricated by LAN TECHNICAL SERVICE Co., Ltd. (SKB1102N-01)) for 5 minutes.

(2) Forming Adhesive Layer

As the hydrogen silsesquioxane polymer, HSQ (fabricated by Tokyo Ouka Chemical, molecular weight: 8500) is used. The hydrogen silsesquioxane polymer is dissolved in n-butanol (fabricated by Wako Pure Chemical Industries, Ltd.) to provide a final concentration of 15 percent by weight (wt %) based on the total weight of the coating solution, so as to provide a coating solution including the silsesquioxane polymer.

The prepared coating solution is coated on the inorganic support by a spin coating method and dried on a clean hot plate (fabricated by As One Corporation) at 100° C. for 5 minutes.

(3) Activation-Treating

The adhesive layer is activation-treated by a vacuum UHF plasma treatment. For the vacuum UHF plasma treatment, a U-8250 plasma etching device fabricated by Hitachi High-Tech is used.

Activation-Treating Condition

Vacuum plasma treatment (vacuum UHF plasma treatment)

Plasma output: 250 W

Reaction gas: CF₄ gas 50 sccm

Ar gas 100 sccm

Treatment time: 5 minutes

Atmosphere pressure (vacuum degree): 20 Pa

(4) Pressure-Heating Treatment

A heat resistance polymer film is laminated on the adhesive layer and undergoes a pressure-heating treatment.

As the heat resistance polymer film, a polyimide polymer film (XENOMAX, fabricated by Toyobo, thickness of 36 μm) is used.

The pressure-heating treatment uses a film roll laminator (fabricated by MCK) and is performed in a state of contacting the adhesive layer with the heat resistance polymer film on the inorganic support.

Pressure-Heating Condition

Pressure: 5 MPa

Temperature: 150° C.

Film returning speed: 1 m/min

(5) Delaminating

After performing the following long-term temperature resistance test, it is delaminated by laser abrasion according to the following method. The delaminating uses an excimer laser device (fabricated by COHERENT JAPAN, INC.).

In other words, the Xe—Cl excimer laser (wavelength: 308 nm) is irradiated on the glass substrate to delaminate the interface between the adhesive layer and the film (interlayer delamination and interface delamination). The energy density of the Xe—Cl excimer laser is 250 mJ/cm² on the adhesive layer and the radiation time thereof is 20 nanoseconds.

Thickness of Adhesive Layer

The thickness of the adhesive layer is measured using a probe-type surface morphology analyzer (Dektak 8).

The formed adhesive layer has a thickness of 500 nm.

### Example 2

A hydrogen silsesquioxane polymer is used as the silsesquioxane polymer, the activation-treatment is performed with an excimer lamp radiation treatment, and the pressure-heating treatment is performed using a roll laminator to provide a laminated structure including an adhesive layer including a silsesquioxane polymer between the inorganic support and the heat resistance polymer film.

Specifically, it is performed in accordance with the same procedure as in Example 1, except that the process (3) of Example 1 is changed into the excimer lamp radiation treatment having the following conditions.

The activation-treatment uses an excimer lamp radiation device (fabricated by Senengineering Co., Ltd.).

Activation Treatment Condition

Excimer lamp radiation treatment

Xe—Cl: excimer lamp (wavelength: 308 nm)

Energy density: 250 mJ/cm²

Radiation time: 20 s

### Example 3

A hydrogen silsesquioxane polymer is used as the silsesquioxane polymer, the activation-treatment is performed with vacuum plasma treatment, and the pressure-heating treatment is performed using a vacuum heating press to provide a laminated structure including the adhesive layer including a silsesquioxane polymer between an inorganic support and a heat resistance polymer film.

This example is performed in accordance with the same procedure as in Example 1, except that a vacuum heating press (KVHC, fabricated by Kitagawa Denki) is used in the process (4) of Example 1 (pressure: 45 MPa, vacuum degree: 10⁻¹ Pa, heating temperature: 270° C., pressure-heating time: 30 min).

### Example 4

A hydrogen silsesquioxane polymer is used as the silsesquioxane polymer, the activation-treatment is not performed, and the pressure-heating treatment is performed using a roll laminator to provide a laminated structure including an adhesive layer including a silsesquioxane polymer disposed between an inorganic support and a heat resistance polymer film.

Specifically, this example is performed in accordance with the same procedure as in Example 1, except that the activation-treatment of the process (3) is not performed.

### Example 5

A phenyl silsesquioxane polymer (silsesquioxane polymer wherein each R¹ is a phenyl group in the structural unit represented by Chemical Formula 1) is used as the silsesquioxane polymer, the activation-treatment is performed with a vacuum plasma treatment, and the pressure-heating treatment is performed using a roll laminator to provide a laminated structure including an adhesive layer including a silsesquioxane polymer disposed between an inorganic support and a heat resistance polymer film.

Specifically, this example is performed in accordance with the same procedure as in Example 1, except that the silsesquioxane polymer is substituted to a phenyl silsesquioxane polymer in the process (2) of Example 1.

Forming Adhesive Layer

SR-20 (Konishi Chemical Ind. Co., Ltd., molecular weight: 16,900) is used as the phenyl silsesquioxane polymer. The phenyl silsesquioxane polymer is dissolved in a propylene glycol monomethyl ether acetate (PGMEA) (fabricated by Showa-denko) to provide a final concentration of 5 wt % based on the total weight of the coating solution, so as to provide a coating solution including the silsesquioxane polymer. The prepared coating solution is coated on an inorganic support according to a spin coating method and dried on a clean hot plate (fabricated by As One Corporation) at 100° C. for 5 minutes. The formed adhesive layer has a thickness of 1,000 nm.

### Comparative Example 1

This example is performed in accordance with the same procedure as in Example 4, except that the silsesquioxane polymer is substituted to an epoxy polymer (fabricated by EPICLON HP-6000 DIC), and the adhesive layer has a thickness of 2,000 nm.

### Comparative Example 2

It is performed in accordance with the same procedure as in Example 4, except that the silsesquioxane polymer is substituted to an acrylic polymer (CE-6400, fabricated by DIC), and the adhesive layer has a thickness of 1,000 nm.

### Comparative Example 3

This example is performed in accordance with the same procedure as in Example 4, except that the silsesquioxane polymer is substituted by a silicone polymer (fabricated by Shinetsu), and the adhesive layer has a thickness of 1,500 nm.

### Comparative Example 4

The silsesquioxane polymer in Example 1 has been replaced with an inorganic silica.

In the process (2) of Example 1, the inorganic silica is coated on the inorganic support by a vacuum depositing device (ULEYES; fabricated by ULVAC Inc.). In addition, the same treatments as in Example 1 are performed, except that the adhesive layer has a thickness of 300 nm.

Examples are compared to comparative examples on the following four points:

Measuring Heat Resistance

Using a thermal analyzer (TG-DTA) fabricated by Rigaku Corporation, a weight decrease is measured from room temperature to 500° C.

Long-Term High Temperature Resistance

The surface is observed after heating (high temperature process) in an oven (DN410I, fabricated by Yamato Scientific Co., Ltd) under a nitrogen atmosphere at 350° C. for 2 hours and evaluated by the following criteria.

∘: no change

Δ: notifying color change or deformation (crack or the like)

x: generating both discolor and deformation (crack or the like)

Appearance Test: Bubble Generation Degree

After the high temperature process, it is evaluated for the appearance test as follows:

“⊚” indicating no bubbles in the laminated structure;

“∘” indicating several spherical shaped bubbles having a size of less than or equal to about 5 μm; and

“x” indicating several tens of bubbles having a size of less than or equal to about 5 μm or indicating bubbles having a size of greater than about 5 μm.

Adhesion Evaluation: 180° Peel Test

The obtained laminated structure is cut into a specimen (25 mm×100 mm) and evaluated according to a 180° peel test (based on peel adhesion strength of JIS Z0237) at room temperature.

Specifically, between both circumference surfaces of strip specimens cut from the laminated structure, the principle surface on the side of the glass substrate is held flat, and then the end part of the heat resistance polymer film is held in a chuck to face the principle surface on the side of the heat resistance polymer film and folded back at 180° to evaluate the adhesion strength (N/cm) when peeling at a speed of 5 mm/s.

The adhesion strength is measured by a texture analyzer (fabricated by SHIMADZU Cooperation).

The adhesion strength of the laminated structure is evaluated by the following:

“⊚” indicates greater than or equal to 10 N/cm;

“∘” Vindicates less than 10 N/cm and greater than or equal to 1 N/cm;

“Δ” indicates less than 1 N/cm; and

“x” indicates one peeled by a cut while fabricating a specimen and that is impossible to be examined.

The adhesion is evaluated before and after the high temperature process.

Evaluation after Delamination

After the delamination, the adhesive layer does not remain on the heat resistance film and remains on the inorganic support.

In order to evaluate the delamination, the surface of the heat resistance film is analyzed by FT-IR equipment (fabricated by Thermo Fisher Scientific K.K.) and the remaining amount is found. Particularly, it is confirmed that the adhesive layer does not remain on the side of the film, based on the results that there is no O—Si—O stretching mode spectrum in the frequency range of 900 cm⁻¹ to 1200 cm⁻¹.

TABLE 1

| | | | | | | Comp. | Comp. | Comp. | |
|---|---|---|---|---|---|---|---|---|---|
| | Ex. 1 | Ex. 2 | Ex. 3 | Ex. 4 | Ex. 5 | Ex. 1 | Ex. 2 | Ex. 3 | Comp. Ex. 4 |
| Adhesion layer | HSQ | HSQ | HSQ | HSQ | SR-20 | Epoxy | Acryl | Silicon | Inorganic Silica |
| Activation | Vacuum | Excimer | Vacuum | — | Vacuum plasma | — | — | — | Vacuum plasma |
| treatment | plasma (CF₄/ | laser | plasma (CF₄/ | | (CF₄/Ar | | | | (CF₄/Ar |
| | Ar mixed gas) | | Ar mixed gas) | | mixed gas) | | | | mixed gas) |
| Pressure-heating | Laminate | Laminate | Vacuum press | Laminate | Laminate | Laminate | Laminate | Laminate | Laminate |
| treatment | | | | | | | | | |
| Heat resistance | >500° C. | >500° C. | >500° C. | >500° C. | >500° C. | 270° C. | 200° C. | 300° C. | >500° C. |
| Long-term high | ⊚ | ⊚ | ⊚ | ◯ | ◯ | X | X | Δ | ⊚ |
| temperature | | | | | | | | | |
| resistance | | | | | | | | | |
| Bubble generation | ⊚ | ⊚ | ⊚ | ◯ | ◯ | X | X | X | ⊚ |
| 180° peeling | ⊚ | ⊚ | ⊚ | ⊚ | ⊚ | ⊚ | ⊚ | ⊚ | X |
| experiment before | | | | | | | | | |
| high temperature | | | | | | | | | |
| process | | | | | | | | | |
| 180° peeling | ⊚ | ◯ | ⊚ | ◯ | ◯ | X | X | ◯ | X |
| experiment after | | | | | | | | | |
| high temperature | | | | | | | | | |
| process | | | | | | | | | |
| Thickness of | 500 nm | 500 nm | 500 nm | 500 nm | 1000 nm | 2000 nm | 1000 nm | 1500 nm | 300 nm |
| adhesive layer | | | | | | | | | |

Inorganic support: glass substrate: 700 μm
Heat resistance polymer film: polyimide film: 36 μm

As shown in Table 1, it is understood that the laminated structure according to the embodiment suppresses the adhesive layer decomposition or bubble generation during the high temperature process, and the long-term high temperature resistance is enhanced.

While this disclosure has been described in connection with what is presently considered to be practical exemplary embodiments, it is to be understood that the invention is not limited to the disclosed embodiments, but, is intended to cover various modifications and equivalent arrangements included within the spirit and scope of the appended claims.

What is claimed is:

1. A laminated structure comprising:
an inorganic support;
a heat resistance polymer film; and
an adhesive layer comprising at least a silsesquioxane polymer disposed between the inorganic support and the heat resistance polymer film.

2. The laminated structure of claim 1, wherein the silsesquioxane polymer comprises a structural unit represented by Chemical Formula 1:
*-[R¹SiO_{3/2}]-* Chemical Formula 1
wherein, in the Chemical Formula 1,
R¹ is selected from hydrogen, a C1-C15 alkyl group and a C6-C15 aromatic hydrocarbon group; and
* represents a point of attachment to an adjacent structural unit.

3. The laminated structure of claim 2, wherein the silsesquioxane polymer comprises a structural unit represented by Chemical Formula 2:
*-[HSiO_{3/2}]-*, Chemical Formula 2
wherein in the Chemical Formula 2,
* represents a point of attachment to an adjacent structural unit.

4. The laminated structure of claim 1, wherein the silsesquioxane polymer is a ladder-type silsesquioxane polymer.

5. The laminated structure of claim 1, wherein the heat resistance polymer film is at least one selected from a polyimide film, a polyamide film, a polybenzoxazole film, and a fluorinated polymer film.

6. The laminated structure of claim 1, wherein the adhesive layer has a thickness of about 50 nanometers to about 10 micrometers.

7. A method of fabricating a laminated structure, comprising:
disposing an adhesive layer comprising at least one silsesquioxane polymer on an inorganic support;
activating the adhesive layer;
disposing a heat resistance polymer film on the adhesive layer to obtain a laminated structure precursor; and
heating the laminated structure precursor under pressure to obtain the laminated structure.

8. The method of claim 7, wherein the activating the adhesive layer is carried out by at least one method selected from plasma treatment, radioactive ray radiation treatment, corona treatment, laser photo-radiation treatment, active gas treatment, and reagent treatment.

9. The method of claim 7, wherein the silsesquioxane polymer comprises a structural unit represented by Chemical Formula 1:
*-[R¹SiO_{3/2}]-* Chemical Formula 1
wherein, in the Chemical Formula 1,
R¹ is selected from hydrogen, a C1-C15 alkyl group and a C6-C15 aromatic hydrocarbon group; and
* represents a point of attachment to an adjacent structural unit.

10. The method of claim 9, wherein the silsesquioxane polymer comprises a structural unit represented by Chemical Formula 2:
*-[HSiO_{3/2}]-*, Chemical Formula 2
wherein in the Chemical Formula 2,
* represents a point of attachment to an adjacent structural unit.

11. A method of fabricating an electronic device, comprising:
forming an electronic device on the heat resistance polymer film of the laminated structure of claim 1, and
delaminating the heat resistance polymer film provided with the electronic device from the adhesive layer.

12. The method of claim 11, wherein the delaminating is performed by laser abrasion or mechanical delamination.

13. A method of fabricating an electronic device, comprising:
forming an electronic device on the heat resistance polymer film of the laminated structure obtained by the method of claim 7, and
delaminating the heat resistance polymer film provided with the electronic device from the adhesive layer.

14. The method of claim 13, wherein the delaminating is performed by laser abrasion or mechanical delamination.
